(19) United States
(12) Patent Application Publication
(10) Pub. No.: US 2010/0023166 A1
(43) Pub. Date: Jan. 28, 2010

(54) FREE-COOLING LIMITATION CONTROL FOR AIR CONDITIONING SYSTEMS

(75) Inventors: Julien Chessel, Villieu Loyes Mollon (FR); Pierre Delpech, Fleurier-sur-Saone (FR); Damien Poux, Lyon (FR)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: CARRIER CORPORATION, Farmington, CT (US)

(21) Appl. No.: 12/520,831

(22) PCT Filed: Dec. 21, 2006
(86) PCT No.: PCT/US06/48910

§ 371 Date: Jun. 22, 2009

(51) Int. Cl. G05B 15/00; F25B 1/00

(52) U.S. Cl. 700/275; 62/498

(57) ABSTRACT

An air conditioning system having a cooling mode and a free-cooling mode. The system includes a refrigeration circuit have a compressor, a pump, an expansion device having a variable opening, and a controller. The controller selectively operates the system in the cooling mode by circulating and compressing a refrigerant through the refrigeration circuit via said compressor, or in the free-cooling mode by circulating the refrigerant through the refrigeration circuit via the pump. A free-cooling limitation and variation sequence resides on said controller and varies the variable opening based at least upon a differential temperature.

### BACKGROUND OF THE INVENTION

1. Field of the Invention

The present disclosure relates to air conditioning systems. More particularly, the present disclosure relates to methods and systems for controlling air conditioning systems having a free-cooling mode and a cooling mode.

2. Description of Related Art

An air conditioning system operates by expending energy to cool a given volume of air. Typically, air conditioning systems are run in a chiller or cooling mode, which includes circulating a refrigerant through a thermodynamic cycle. During the cycle, heat and work are transferred to the refrigerant. The refrigerant enters a heat exchanger and chills a working fluid such as water, which in turn can be used to cool a conditioned space. Work is generally transferred to the refrigerant using a compressor.

However, when the temperature of the ambient outside air is low, the outside air may be used to cool the refrigerant without engaging the compressor. When ambient outside air is used by an air conditioning system to cool the refrigerant, the system is referred to as operating in a free-cooling mode. Because running the air conditioning system in a free-cooling mode requires less work input, running the system in free-cooling mode is more efficient than running the system in cooling mode.

Traditionally, air conditioning systems have been run in cooling mode even when the ambient outside air temperature is low. Running in cooling mode under such conditions provides a low efficiency means of conditioning the refrigerant. In contrast, running the air conditioning system under such conditions in a free-cooling mode is more efficient. In the free-cooling mode, one or more ventilated heat exchangers and pumps are activated and the refrigerant circulating throughout the air conditioning system is cooled by outside ambient air without the need for a compressor.

Air conditioning units may be configured to operate using a cooling mode and a free-cooling mode. Accordingly, there is a need for methods and systems that improve the efficiency and control of air conditioning systems having a free-cooling mode.

### BRIEF SUMMARY OF THE INVENTION

Air conditioning systems and methods of controlling are provided that, when operating in free-cooling mode, include a free-cooling limitation and variation sequence that varies an opening of an expansion device based at least upon a temperature difference between working fluid leaving the air conditioning system and outside ambient air.

An air conditioning system having a cooling mode and a free-cooling mode is provided. The system includes a refrigeration circuit have a compressor, a pump, an expansion device having a variable opening, and a controller. The controller selectively operates the system in the cooling mode by circulating and compressing a refrigerant through the refrigeration circuit via the compressor, or in the free-cooling mode by circulating the refrigerant through the refrigeration circuit via the pump. A free-cooling limitation and variation sequence resides on the controller and varies the variable opening based at least upon a differential temperature.

A method of controlling an air conditioning system having a cooling mode and a free-cooling mode is also provided. The method includes determining a differential temperature between an outside ambient air and a conditioned working fluid, operating the system in the cooling mode when the differential temperature is below a first predetermined level, operating the system in the free-cooling mode with a refrigerant expansion device fully opened when the differential temperature is above a second predetermined level, and partially opening the refrigerant expansion device based on the differential temperature to operate the system in the free-cooling mode when the differential temperature is between the first the second predetermined levels.

The above-described and other features and advantages of the present disclosure will be appreciated and understood by those skilled in the art from the following detailed description, drawings, and appended claims.

### BRIEF DESCRIPTION OF THE SEVERAL VIEWS OF THE DRAWINGS

FIG. 1 is an exemplary embodiment of an air conditioning system in free-cooling mode according to the present disclosure;

FIG. 2 is an exemplary embodiment of an air conditioning system in cooling mode according to the present disclosure;

FIG. 3 illustrates an exemplary embodiment of a method of operating the air conditioning systems of FIGS. 1 and 2; and

FIG. 4 is a graph illustrating an exemplary free-cooling operating range of the air conditioning systems of FIGS. 1 and 2.

### DETAILED DESCRIPTION OF THE INVENTION

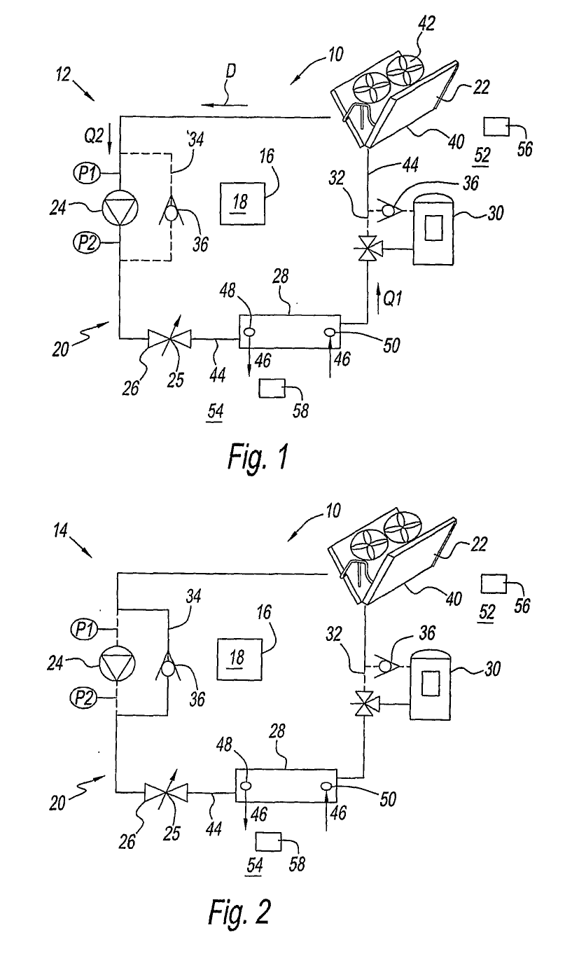

Referring now to the drawings and in particular to FIGS. 1 and 2, an exemplary embodiment of an air conditioning system is shown, generally referred to by reference numeral 10. System 10 is configured to operate in a free-cooling mode 12 (FIG. 1) and a cooling mode 14 (FIG. 2).

System 10 includes a controller 16 for selectively switching between free-cooling and cooling modes 12, 14. Advantageously, controller 16 includes a limitation and variation control sequence 18 that monitors one or more conditions in system 10, when operating in free-cooling mode 12, and adjust the size of an opening of an expansion device to maintain sufficient pressure in system 10 and to prevent pump damage. In this manner, limitation and variation control sequence 18 improves performance of system 10 during free-cooling mode 12 as compared to prior art systems.

System 10 includes a refrigeration circuit 20 having a condenser 22, a pump 24, an expansion device 26, an evaporator 28, and a compressor 30. Controller 16 is configured to selectively control either pump 24 (when in free-cooling mode 12) or compressor 30 (when in cooling mode 14) to circulate the refrigerant through system 10 in a flow direction (D). Thus, system 10, when in free-cooling mode 12, controls pump 24 to circulate the refrigerant in flow direction D. However, system 10, when in cooling mode 14, controls compressor 30 to compress and circulate the refrigerant in flow direction D. Free-cooling mode 12 uses less energy than cooling mode 14 because free-cooling mode 12 does not require additional work input to operate compressor 30.

System 10 includes a compressor by-pass loop 32 and a pump by-pass loop 34. System 10 includes one or more valves 36 controlled by controller 16, allowing the controller to selectively position valves 36 to selectively open and close by-pass loops 32, 34 as needed.

In cooling mode 14, controller 16 controls valves 36 so that compressor by-pass loop 32 is closed and pump by-pass loop 34 is open. In this configuration, system 10 allows compressor 30 to compress and circulate the refrigerant in the flow direction D by flowing through pump by-pass loop 34.

In contrast, controller 16, when in free-cooling mode 12, controls valves 36 so that compressor by-pass loop 32 is open and pump by-pass loop 34 is closed. In this configuration, system 10 allows pump 24 to circulate refrigerant in flow direction D by flowing through compressor by-pass loop 32.

Accordingly, system 10 provides heat transfer between a refrigerant 44 and a working fluid 46, in evaporator 28. Heat is transferred from working fluid 46 to refrigerant 44, cooling working fluid 46. Cooled working fluid 46 exits evaporator 28 at an outlet 48, circulates throughout the area to be cooled, and returns to the evaporator through an inlet 50. This process occurs in both free-cooling and cooling modes 12, 14. Refrigerant 44 can be R22, R410A, or any other known refrigerant. Working fluid 46 can be air, water, glycol, or any other fluid known in the art.

In cooling mode 14, system 10 operates as a standard vapor-compression air conditioning system known in the art where the compression and expansion of the refrigerant via expansion device 26 are used to condition working fluid 46. Expansion device 26 can be any known expansion device such as, but not limited to a controllable expansion device (e.g., a thermal expansion valve). In one preferred embodiment, expansion device 26 is an electronically controllable expansion valve. In another preferred embodiment, expansion device 26 is a two-way valve. In the example where expansion device 26 is a controllable expansion device, the expansion device is preferably controlled by controller 16.

In free-cooling mode 12, system 10 takes advantage of the heat removing capacity of outside ambient air 40, which is in heat exchange relationship with condenser 22 via one or more fans 42. The efficacy of free-cooling mode 12 depends on the difference or differential temperature (Delta T or ΔT) between the temperature 52 of the outside ambient air 40 and the temperature of the working fluid 46 as it leaves evaporator 28 through outlet 48 (leaving temperature 54). That is, ΔT=(leaving temperature 54)−(outside air temperature 52). Generally, free-cooling mode 12 is more effective at higher values of ΔT.

In one exemplary embodiment, ΔT is determined using a first temperature sensor 56 and a second temperature sensor 58. First temperature sensor 56 is positioned to measure outside air temperature 52, while second temperature sensor 58 is positioned to measure leaving temperature 54. Preferably, controller 16 interfaces with first and second temperature sensors 56, 58 to calculate ΔT. First and second temperature sensors 56, 58 can be any temperature-sensing element known in the art, including, but not limited to, a thermocouple and a thermistor.

While system 10 is operating in free cooling mode 12, refrigerant 44 naturally migrates toward the coldest point of circuit 20. In one exemplary embodiment, condenser 22 is the coldest point of circuit 20, and refrigerant 44 moves from evaporator 28 toward condenser 22, generating a first flow rate Q1. Working fluid 44 exiting condenser 22 is pumped by pump 24 to generate a second flow rate Q2 toward expansion device 26. The manufacturer of pump 24 defines a low limit flow rate Q3, which is the lower limit at which pump 24 can operate safely without causing damage to the pump.

When the difference ΔT between outside air temperature 52 and leaving temperature 54 is small, first flow rate Q1 will decrease, and may become lower than second flow rate Q2. When this occurs, the amount of refrigerant 44 stocked in condenser 28 will be depleted, and running system 10 in free-cooling mode 12 may cause damage to pump 24. Low limit flow rate Q3 defines the lower limit at which pump 24 can operate. To avoid damage to pump 24, second flow rate Q2 must be maintained at a value that is higher than low limit flow rate Q3 and lower that first flow rate Q1.

It has been determined by the present disclosure that refrigerant leaving condenser 22 can be in one of several different phases, namely a gas phase, a liquid-gas phase, or a liquid phase. After controller 16 initiates free-cooling mode 14 and during the time it takes for system 10 to reach equilibrium, pump 24 is supplied with refrigerant in the different phases. Unfortunately, when pump 24 is supplied with refrigerant in the gas or liquid-gas phases, the pump does not operate as desired. Moreover, the gas phase and/or liquid-gas phase refrigerant can cause pump 24 to cavitate and/or diffuse, which can damage the pump and/or the pump motor (not shown).

Advantageously, controller 16 includes limitation and variation control sequence 18 that monitors and varies one or more conditions in circuit 20 to mitigate and/or prevent damage to pump 24.

Free cooling mode 12 is initiated only when there is sufficient pressure drop in system 10. Prior art systems were not able to provide sufficient pressure drop in system 10 for low values of ΔT. Advantageously, the present disclosure provides for running system 10 in free cooling mode 12 when ΔT is small. By varying the size of an opening 25 of expansion device 26, controller 16 is able to maintain a desired pressure drop within system 10, even for small values of ΔT. Controller 16 controls the size of opening 25 through pressure limitation and variation sequence 18.

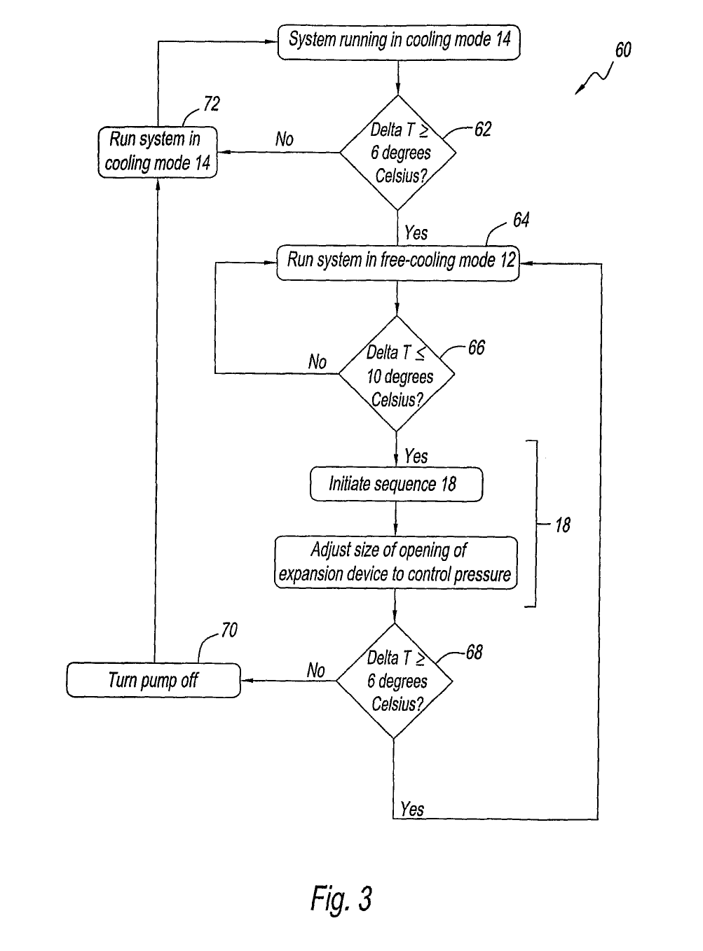

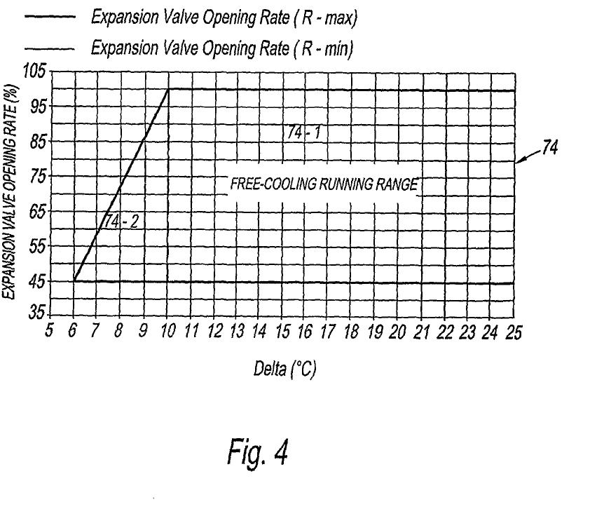

FIGS. 3 and 4 describe in greater detail the operation of limitation and variation sequence 18. FIG. 3 illustrates an exemplary embodiment of a method 60 for operating system 10. FIG. 4 is a graph showing an exemplary range in which system 10 can operate in free-cooling mode 12.

Method 60, when system 10 is operating in cooling mode 14, includes a first temperature comparison step 62. During first temperature comparison step 62, method 60 determines whether the difference ΔT between the temperature 52 of outside ambient air 40 and leaving temperature 54 of working fluid 46 is sufficient for system 10 to switch to free-cooling mode 12. If ΔT is less than a first predetermined temperature, illustrated as about 6 degrees Celsius (° C.), system 10 continues to run in cooling mode 14. However, if ΔT is equal to or greater than the first predetermined temperature, method 60 performs a switching step 64, so that system 10 operates in free-cooling mode 12. After switching step 64, method 60 performs a second temperature comparison step 66 to determine whether ΔT is less than a second predetermined temperature, illustrated as about 10° C. If ΔT is equal to or greater than the second predetermined temperature, system 10 continues to run in free-cooling mode 12. If ΔT is less than the second predetermined temperature, controller 16 initiates sequence 18 to vary the size of opening 25 of expansion device 26 to maintain sufficient pressure drop and flow rates in system 10 to pump 24.

Thus, method 60, due to the initiation of sequence 18, controls system 10 based at least on ΔT to selectively restrict flow through expansion device 26 to maintain a predetermined pressure drop across pump 24. Below the first predetermined temperature, method 60 operates in cooling mode 14. Above the second predetermined temperature, method 60 operates system 10 in unrestricted free-cooling mode 12, namely with expansion device 26 in a fully open position. However, between the first and second predetermined temperatures, method 60 operates in a restricted or limited free-cooling mode 12, where method 60 varies expansion device 26 anywhere between a fully open position and a substantially closed position, and any sub-ranges therebetween.

Method 60 continues operating in free-cooling mode 12 after initiating sequence 18 and, in some embodiments includes a third temperature comparison step 68. Much like first comparison step 80 discussed above, third comparison step 80 determines that if ΔT is greater than or equal to the first predetermined temperature, system 10 continues to run in free-cooling mode 12. However, if ΔT is less than the first predetermined temperature, sequence 18 turns pump 24 to the “off” state at a pump shut down step 70 and switches system 10 back to cooling mode 14 at a cooling mode switching step 90.

FIG. 6 is a graph illustrating the operating range 74 in which system 10 can operate in free-cooling mode 12. Here, operating range 74 includes an unrestricted portion 74-1 and a restricted portion 74-2. The x-axis of the graph shows ΔT in degrees Celsius; the y-axis of the graph shows the expansion device 26 opening size R as a percentage of the opening size of the expansion device in its fully opened state R_full.

In the illustrated embodiment, opening size R is fully open (e.g., 100) during unrestricted portion 74-1 of free-cooling mode 12. However, opening size R is varied by sequence 18 between being a partially closed (e.g., 45) and fully open (e.g., 100). As shown, the change in percent open of expansion device 26 is linear with respect to the change in ΔT. However, it is contemplated by the present disclosure for sequence 18 to control expansion device 26 in a manner, with respect to changes in ΔT, that is linear, non-linear, and any combinations thereof.

The present disclosure has determined that for low values of ΔT, especially between the first and second predetermined temperatures, pump 24 does not operate as desired without controlling opening 25 of expansion device 26. In some embodiments, the minimum value of R (R_min) can be approximately 45, that is, to allow for sufficient flow rates, the minimum size of opening 25 of expansion device 26 is about 45% of R_full.

Sequence 18 is configured to continuously adjust the size of opening 25 of expansion device 26 to maintain a desired pressure drop within system 10 and to maintain the flow rates such that Q3<Q2<Q1. When the appropriate pressure drop and/or flow rates cannot be maintained through adjustment of the expansion device opening, controller 16 switches system 10 from free-cooling mode 12 to cooling mode 14.

It should be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. An air conditioning system having a cooling mode and a free-cooling mode, the system comprising:
a refrigeration circuit have a compressor, a pump, and an expansion device having a variable opening;
a controller for selectively operating in the cooling mode by circulating and compressing a refrigerant through said refrigeration circuit via said compressor or operating in the free-cooling mode by circulating said refrigerant through said refrigeration circuit via said pump; and
a free-cooling limitation and variation sequence resident on said controller, said free-cooling limitation and variation sequence varying said variable opening based at least upon a differential temperature.

2. The system of claim 1, wherein said free-cooling limitation and variation sequence varies said variable opening linearly with respect to said differential temperature.

3. The system of claim 1, wherein said free-cooling limitation and variation sequence varies said variable opening non-linearly with respect to said differential temperature.

4. The system of claim 1, further comprising:
a heat exchanger wherein heat is transferred between said refrigerant and a working fluid; and
a first temperature sensor and a second temperature sensor, said first temperature sensor and said second temperature sensor interfacing with said controller,
wherein said first temperature sensor measures a first temperature of outside ambient air, and said second temperature sensor measures a
second temperature of said working fluid leaving said heat exchanger, and
wherein said controller determines said differential temperature based on said first temperature and said second temperature.

5. The system of claim 1 wherein said free-cooling limitation and variation sequence partially opens said variable opening when said differential temperature is within a predetermined range.

6. The system of claim 5, wherein said free-cooling limitation and variation sequence fully opens said variable opening when said differential temperature is above said predetermined range.

7. The system of claim 6, wherein said free-cooling limitation and variation sequence switches the system from said free-cooling mode to said cooling mode when said differential temperature is below said predetermined range.

8. A method of controlling an air conditioning system having a cooling mode and a free-cooling mode, the method comprising:
determining a differential temperature between an outside ambient air and a conditioned working fluid;
operating the system in the cooling mode when said differential temperature is below a first predetermined level;
operating the system in the free-cooling mode with a refrigerant expansion device fully opened when said differential temperature is above a second predetermined level; and
partially opening said refrigerant expansion device based on said differential temperature to operate the system in the free-cooling mode when said differential temperature is between said first and said second predetermined levels.

9. The method of claim 8, wherein the step of partially opening said refrigerant expansion device based on said differential temperature is performed by varying an opening of said refrigerant expansion device with respect to said differential temperature in a linear manner.

10. The method of claim 9, wherein said first predetermined level is approximately six degrees Celsius.

11. The method of claim 9, wherein said second predetermined level is approximately ten degrees Celsius.

12. The method of claim 8, wherein the step of partially opening said refrigerant expansion device based on said differential temperature is performed by varying an opening of said expansion device with respect to said differential temperature in a non-linear manner.

13. An air conditioning system or method for controlling an air conditioning system as described with reference to any one of FIGS. 1 through 4.
